(19) United States
(12) Patent Application Publication
(10) Pub. No.: US 2023/0343919 A1
(43) Pub. Date: Oct. 26, 2023

(54) MANUFACTURE OF ELECTRODES FOR ENERGY STORAGE DEVICES

(71) Applicant: FastCAP Systems Corporation, Wakefield, MA (US)

(72) Inventors: Ji Chen, Malden, MA (US); Wanjun Ben Cao, Boston, MA (US); Ki Park, Chestnut Hill, MA (US); Nicolo Brambilla, Brookline, MA (US); Jin Yan, Malden, MA (US)

(21) Appl. No.: 18/247,849

(22) PCT Filed: Oct. 5, 2021
(86) PCT No.: PCT/US2021/053519

§ 371 Date: Apr. 4, 2023

Related U.S. Application Data
(60) Provisional application No. 63/087,507, filed on Oct. 5, 2020.

(51) Int. Cl. H01M 4/04; H01M 4/587; H01M 10/0525; H01M 4/133; H01G 11/28; H01G 11/36; H01G 11/86

(52) U.S. Cl. CPC H01M 4/0404; H01M 4/0435; H01M 4/587; H01M 10/0525; H01M 4/133; H01G 11/28; H01G 11/36; H01G 11/86

(57) ABSTRACT

A method for fabricating an electrode for an energy storage device is provided. The method includes heating a mixture of solvent and materials for use as energy storage media; adding active material to the mixture; adding dispersant to the mixture to provide a slurry; coating a current collector with the slurry; and calendaring the coating of slurry on the current collector to provide the electrode.

### CROSS-REFERENCE TO RELATED APPLICATIONS

This reference claims priority to U.S. Provisional Application 63/087,507 filed on Oct. 5, 2020, the entire contents of which are hereby incorporated by reference.

### BACKGROUND OF THE INVENTION

### 1. Field of the Invention

The invention disclosed herein relates to energy storage devices, and in particular to the manufacture of electrodes for batteries and ultracapacitors.

### 2. Description of the Related Art

The increasing use of renewable energy has brought many benefits as well as challenges. Perhaps the most significant challenge is development of efficient energy storage. In order to truly capitalize on renewable energy sources, inexpensive and high-power energy storage is needed. In fact, a myriad of other industries would benefit from improved energy storage. One example is the automotive industry with the increasing drive to electric and hybrid vehicles.

Perhaps the most pervasive and convenient form of energy storage is that of the battery. Batteries share a variety of features with electrolytic double layer capacitors (EDLC). For example, such devices typically include a layer of anode material separated from a layer of cathode material by a separator. Electrolyte provides for ionic transport between these electrodes to provide the energy.

In the prior art, electrodes of energy storage devices typically include some form of binder mixed into the energy storage materials. That is, the binder is essentially a form of glue ensures adhesion to a current collector. Unfortunately, the binder material, which provides for physical integrity of the electrode, is typically non-conductive and results poor performance and degraded operation over time. Often, the binder material is toxic and may be expensive.

Many modern applications need improved performance for at least one of energy density, usable life (i.e., cyclability), safety, equivalent series resistance (ESR), cost of manufacture, physical strength and other such aspects. Further, it is preferable that improved devices operate reliably over wide temperature range. Use of binder materials detracts from these performance requirements. Thus, improving the technology used in fabrication of the electrodes (e.g., the anode and the cathode) offers the greatest opportunities to improve the performance of the energy storage device in which the electrodes are used.

As one might imagine, space within an energy storage device comes at a premium. That is, void spaces simply result in lost opportunities for incorporation of energy storage materials. Thus, efficient manufacturing techniques are vital for development of high performance energy storage devices. As one example, application of energy storage media on to a current collector may often result in electrodes with rough surfaces, essentially creating voids within the energy storage device.

Thus, what are needed are methods and apparatus to ensure uniform dispersion of slurries onto current collectors when fabricating energy storage devices.

### SUMMARY OF THE INVENTION

In one embodiment, a method for fabricating an electrode for an energy storage device is provided. The method includes heating a mixture of solvent and materials for use as energy storage media; adding active material to the mixture; adding dispersant to the mixture to provide a slurry; coating a current collector with the slurry; and calendering the coating of slurry on the current collector to provide the electrode.

In another embodiment, an energy storage device incorporating the electrode is provided.

### BRIEF DESCRIPTION OF THE DRAWINGS

The features and advantages of the invention are apparent from the following description taken in conjunction with the accompanying drawings in which:

FIG. 1 is a schematic cutaway diagram depicting aspects of a prior art energy storage device (ESD).

FIG. 2 is a schematic cutaway diagram depicting aspects of a prior art storage cell of the energy storage device (ESD) of FIG. 1.

FIGS. 3A, 3B and 3C, collectively referred to herein as FIG. 3, are schematic diagrams depicting aspects of ionic transport between electrodes in the storage cell of FIG. 2.

FIG. 4 is a flow chart depicting an example of a process for fabrication of an electrode according to the teachings herein.

FIGS. 5, 6, 7 and 8 are schematic diagrams depicting aspects of the materials assembled in the process set forth in FIG. 4.

FIGS. 9A and 9B, collectively referred to herein as FIG. 9, along with FIGS. 10A and 10B, collectively referred to herein as FIG. 10, FIGS. 11A and 11B, collectively referred to herein as FIG. 11, FIGS. 12A and 12B, collectively referred to herein as FIG. 12, FIGS. 13A and 13B, collectively referred to herein as FIG. 13, FIG. 14, and FIGS. 15A and 15B, collectively referred to herein as FIG. 15, and FIG. 16 are photomicrographs of the materials assembled in the process set forth in FIG. 4.

FIGS. 17, 18, 19 and 20 are graphs depicting aspects of electrical performance of energy storage cells assembled with the materials disclosed herein. FIGS. 18A and 18B are collectively referred to herein as FIG. 18.

FIG. 21 is a schematic diagram depicting aspects of an energy storage cells assembled with the materials disclosed herein.

FIGS. 22-43 are illustrate electrical performance of energy storage cells assembled with the materials disclosed herein.

### DETAILED DESCRIPTION OF THE INVENTION

Disclosed herein are methods and apparatus for providing electrodes useful in energy storage devices. Generally, application of the technology disclosed can result in energy storage devices capable of delivering high power, high energy, exhibiting a long lifetime and operating over a wide range of environmental conditions. The technology disclosed is deployable in high-volume manufacturing for a variety of energy storage devices and in a variety of forms. Advantageously, the techniques result in lower costs for fabrication of energy storage devices.

The technology may be used in an energy storage device that is a battery, an ultracapacitor or any other similar type of device making use of electrodes for energy storage. Prior to introducing the technology, some context is provided by way of definitions and an overview of energy storage technology.

As discussed herein, the term “energy storage device” (also referred to as an “ESD”) generally refers to an electrochemical cell. An electrochemical cell is a device capable of either generating electrical energy from chemical reactions or using electrical energy to cause chemical reactions. Electrochemical cells which generate electric current are referred to as “voltaic cells” or “galvanic cells,” and those that generate chemical reactions, via electrolysis for example, are called electrolytic cells. A common example of a galvanic cell is a standard 1.5 volt cell designated for consumer use. A battery consists of one or more cells, connected in parallel, series or series-and-parallel pattern. A secondary cell, commonly referred to as a rechargeable battery, is an electrochemical cell that can be run as both a galvanic cell and as an electrolytic cell. This is used as a convenient way to store electricity, when current flows one way, the levels of one or more chemicals build up (that is, while charging). Conversely, the chemicals reduce while the cell is discharging and the resulting electromotive force may be used to do work. One example of a rechargeable battery is a lithium-ion battery, some embodiments of which are discussed herein.

As a matter of convention, an electrode in an electrochemical cell is referred to as either an “anode” or a “cathode.” The anode is the electrode at which electrons leave the electrochemical cell and oxidation occurs (indicated by a minus symbol, “?”), and the cathode is the electrode at which electrons enter the cell and reduction occurs (indicated by a plus symbol, “+”). Each electrode may become either the anode or the cathode depending on the direction of current through the cell. Given the variety of configurations and states for energy storage devices (ESD) generally, this convention is not limiting of the teachings herein and use of such terminology is merely for purposes of introducing the technology. Accordingly, it should be recognized that the terms “cathode,” “anode” and “electrode” are interchangeable in at least some instances. For example, aspects of the techniques for a fabrication of an active layer in an electrode may apply equally to anodes and cathodes. More specifically, the chemistry and/or electrical configuration discussed in any specific example may inform use of a particular electrode as one of the anode or cathode.

Generally, examples of energy storage device (ESD) disclosed herein are illustrative. That is, the energy storage device (ESD) is not limited to the embodiments disclosed herein.

More specific examples of energy storage device (ESD) include supercapacitors such as double-layer capacitors (devices storing charge electrostatically), psuedocapacitors (which store charge electrochemically) and hybrid capacitors (which store charge electrostatically and electrochemically). Generally, electrostatic double-layer capacitors (EDLCs) use carbon electrodes or derivatives with much higher electrostatic double-layer capacitance than electrochemical pseudocapacitance, achieving separation of charge in a Helmholtz double layer at the interface between the surface of a conductive electrode and an electrolyte. Generally, electrochemical pseudocapacitors use metal oxide or conducting polymer electrodes with a high amount of electrochemical pseudocapacitance additional to the double-layer capacitance. Pseudocapacitance is achieved by Faradaic electron charge-transfer with redox reactions, intercalation or electrosorption. Hybrid capacitors, such as the lithium-ion capacitor, use electrodes with differing characteristics: one exhibiting mostly electrostatic capacitance and the other mostly electrochemical capacitance.

Other examples of energy storage devices (ESD) include rechargeable batteries, storage batteries, or secondary cells which are a type of electrical battery that can be charged, discharged into a load, and recharged many times. During charging, the positive active material is oxidized, producing electrons, and the negative material is reduced, consuming electrons. These electrons constitute the current flow from the external circuit. Generally, the electrolyte serves as a buffer for internal ion flow between the electrodes (e.g., anode and cathode). Battery charging and discharging rates are often discussed by referencing a “C” rate of current. The C rate is that which would theoretically fully charge or discharge the battery in one hour. “Depth of discharge” (DOD) is normally stated as a percentage of the nominal ampere-hour capacity. For example, zero percent (0%) DOD means no discharge.

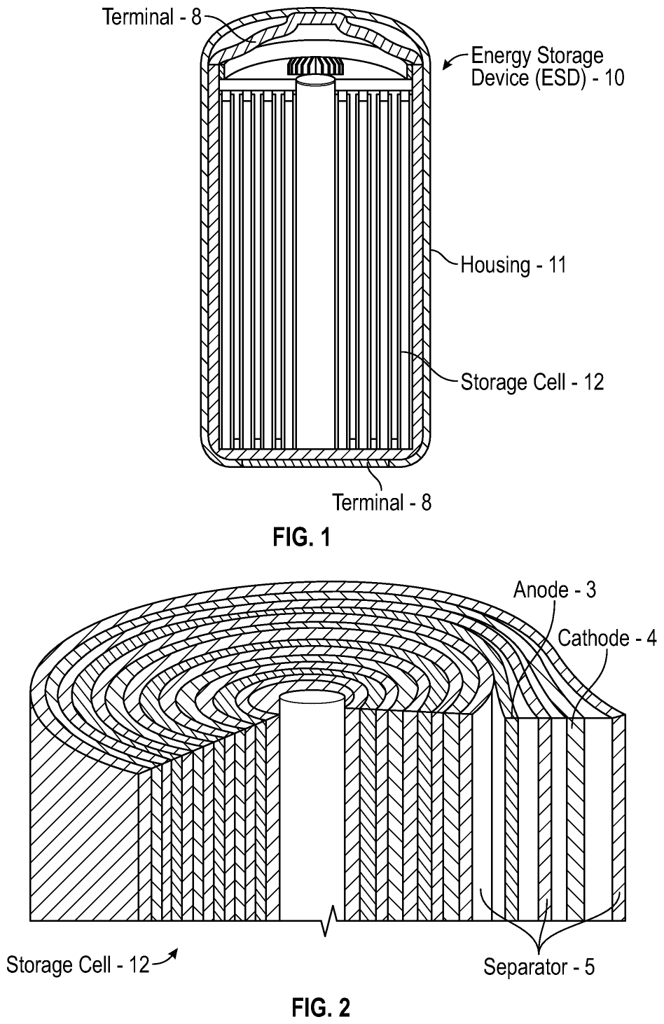

Additional context is provided with regard to FIGS. 1 through 3 which provide an overview of aspects of an energy storage devices (ESD) 10.

In FIG. 1, a cross section of an energy storage device (ESD) 10 is shown. The energy storage device (ESD) 10 includes a housing 11. The housing 11 has two terminals 8 disposed on an exterior thereof. The terminals 8 provide for internal electrical connection to a storage cell 12 contained within the housing 11 and for external electrical connection to an external device such as a load or charging device (not shown).

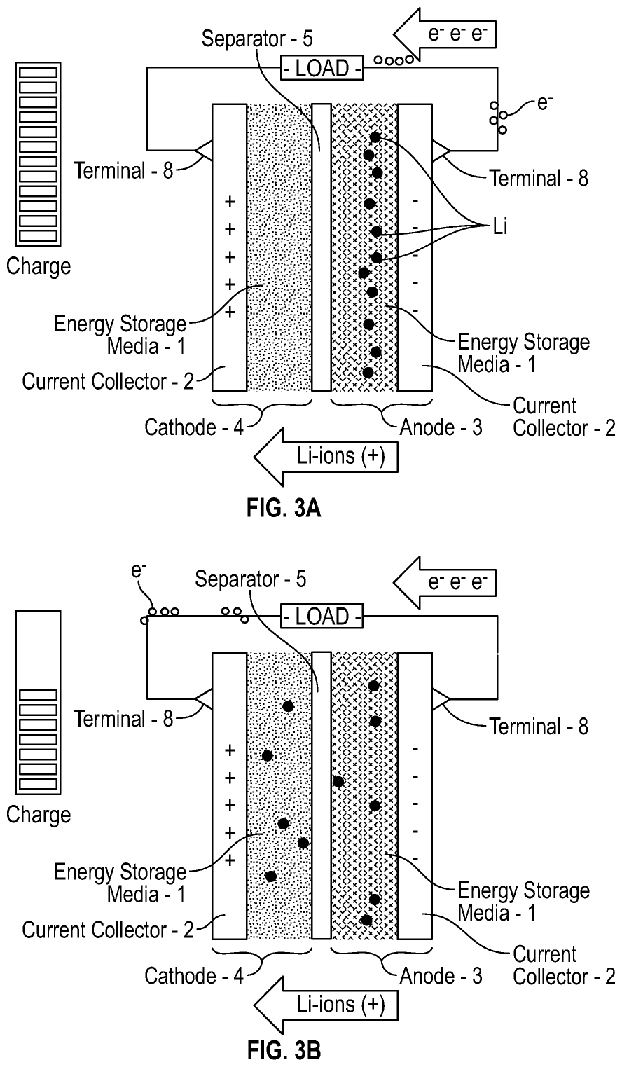

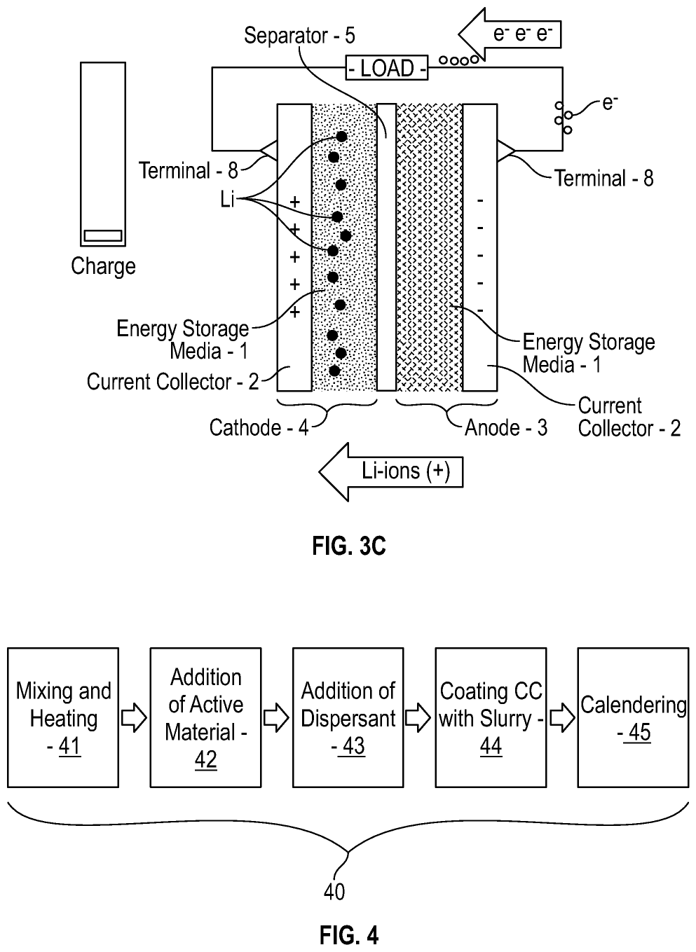

A cutaway portion of the storage cell 12 is depicted in FIG. 2. As shown in this illustration, the storage cell 12 includes a multi-layer roll of energy storage materials. That is, sheets or strips of energy storage materials are rolled together into a roll format. The roll of energy storage materials include opposing electrodes referred to as an “anode 3” and as a “cathode 4.” The anode 3 and the cathode 4 are separated by a separator 5. Not shown in the illustration but included as a part of the storage cell 12 is an electrolyte. Generally, the electrolyte permeates or wets the cathode 4 and the anode 3 and facilitates migration of ions within the storage cell 12. Ionic transport is illustrated conceptually in FIG. 3.

FIGS. 3A, 3B and 3C, collectively referred to herein as FIG. 3, are conceptual diagrams depicting aspects of cell chemistry as a function of the state of charge for the energy storage device (ESD) 10. Specifically, in FIG. 3, a discharge sequence is shown for the energy storage device (ESD) 10 is shown. In this series, the energy storage device (ESD) 10 is a lithium-ion battery. The battery includes the anode 3, the cathode 4, the separator 5, and electrolyte 6 (more on each of these elements is presented below). Generally, the anode 3 and the cathode 4 store lithium.

In FIG. 3A, aspects of a fully charged energy storage device (ESD) 10 are shown. In this illustration, the anode 3 contains energy storage media 1 disposed on a current collector 2. The energy storage media 1 of the anode 3 for a fully charged energy storage device (ESD) 10 substantially contains all of the lithium within the storage cell 12. Similar in construction, the cathode 4 contains energy storage media 1 disposed on a current collector 2.

A load (for example, electronics such as a cell phone, a computer, a tool, or automobile, not shown) is connected to and draws energy from the energy storage device (ESD) 10, electrons (e−) are drawn from the anode 3. Positively charged lithium ions migrate within the storage cell 12 to the cathode 4. This causes depletion of charge as shown in the charge-meter depicted in FIG. 3B. When the energy storage device (ESD) 10 is fully depleted, substantially all of the lithium ions have migrated to the cathode 4, as shown in FIG. 3C.

Swapping a charging device for the load and energizing the charging device causes flow of electrons (e−) to the anode 3 and the attendant migration of the lithium ions from the cathode 4 to the anode 3. Whether discharging or charging, the separator 5 blocks the flow of electrons within the energy storage device (ESD) 10.

In a typical lithium-ion battery, the anode 3 may be made substantially from a carbon based matrix with lithium intercalated into the carbon based matrix. In the prior art, the carbon based matrix often includes a mixture of graphite and binder material. In the prior art, the cathode 4 often includes a lithium metal oxide based material along with a binder material. Conventional processes for fabrication of the electrodes calls for development of a mixture of materials which are then applied to the current collector 2 as the energy storage media 1. Quite often, agglomerations and inconsistencies within the slurry result in a surface of the electrode that is rough or includes peaks and valleys. Problems found in the prior art and arising with the development of slurries of energy storage media 1 can be remedied with fabrication of a slurry according to the teachings herein. An example of a process for mixing slurry is provided in FIG. 4.

In FIG. 4, as an overview, an example of a process for fabrication of an electrode 40 according to the teachings herein is provided. In a first step 41, base materials are mixed and heated. In a second step 42, an addition of active material is made while heating and mixing is ongoing. In a third step 43, an addition of dispersant is made while heating and mixing is ongoing. In a fourth step 44, the resulting mixture is applied to a prepared current collector. In a fifth step 45, the coated current collector is subjected to calendaring.

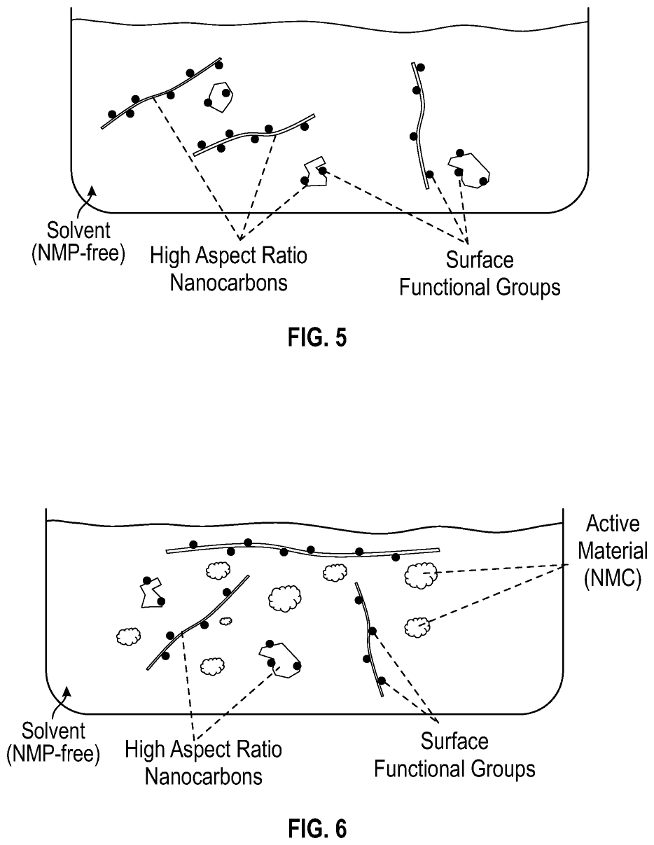

Referring to FIG. 5, further detail regarding the first step 41 is introduced. In the first step 41, a carbon dispersion is prepared. The carbon dispersion includes high aspect ratio nanocarbon materials (or “nanocarbons”) which may be functionalized by the process or provided as functionalized materials. In this example, the first step 41 includes heating to temperatures between about 35 degrees Celsius and 70 degrees Celsius.

As used herein, the term “high aspect ratio carbon elements” and other similar terms refers to carbonaceous elements having a size in one or more dimensions (the “major dimension(s)”) significantly larger than the size of the element in a transverse dimension (the “minor dimension”).

For example, in some embodiments, the high aspect ratio carbon elements may include flake or plate shaped elements having two major dimensions and one minor dimension. For example, in some such embodiments, the ratio of the length of each of the major dimensions may be at least 5 times, 10 times, 100 times, 500 times, 1,000 times, 5,000 times, 10,000 times or more of that of the minor dimension. Exemplary elements of this type include graphene sheets or flakes.

In some embodiments, the high aspect ratio carbon elements may include elongated rod or fiber shaped elements having one major dimension and two minor dimensions. For example, in some such embodiments, the ratio of the length of the major dimensions may be at least 5 times, 10 times, 100 times, 500 times, 1,000 times, 5,000 times, 10,000 times or more of that of each of the minor dimensions. Exemplary elements of this type include carbon nanotubes, bundles of carbon nanotubes, carbon nanorods, and carbon fibers.

In some embodiments, the high aspect ratio carbon elements may include single wall nanotubes (SWNT), double wall nanotubes (DWNT), or multiwall nanotubes (MWNT), carbon nanorods, carbon fibers or mixtures thereof. In some embodiments, the high aspect ratio carbon elements may be formed of interconnected bundles, clusters, or aggregates of CNTs or other high aspect ratio carbon materials. In some embodiments, the high aspect ratio carbon elements may include graphene in sheet, flake, or curved flake form, and/or formed into high aspect ratio cones, rods, and the like.

In some embodiments, a size (e.g., the average size, median size, or minimum size) of the high aspect ratio carbon elements along one or two major dimensions may be at least 0.1 μm, 0.5 μm, 1 μm, 5 μm, 10 μm, 50 μm, 100 μm, 200 μm, 300, μm, 400 μm, 500 μm, 600 μm, 7000 μm, 800 μm, 900 μm, 1,000 μm or more. For example, in some embodiments, the size (e.g., the average size, median size, or minimum size) of the elements may be in the range of 1 μm to 1,000 μm, or any subrange thereof, such as 1 μm to 600 μm.

In some embodiments, the size of the elements can be relatively uniform. For example, in some embodiments, more than 50%, 60%, 70%, 80%, 90%, 95%, 99% or more of the elements may have a size along one or two major dimensions within 10% of the average size for the elements.

Functionalizing the nanocarbons generally includes surface treatment of the nanocarbons. Surface treatment may be performed by any suitable technique such as those described herein or known in the art. Functional groups applied to the nanocarbons may be selected to promote adhesion between the active material particles and the nanocarbons. For example, in various embodiments the functional groups may include carboxylic groups, hydroxylic groups, amine groups, silane groups, or combinations thereof.

In some embodiments, the functionalized carbon elements are formed from dried (e.g., lyophilized) aqueous dispersion comprising nanoform carbon and functionalizing material such as a surfactant. In some such embodiments, the aqueous dispersion is substantially free of materials that would damage the carbon elements, such as acids.

In some embodiments, surface treatment of the high aspect ratio carbon elements includes a thin polymeric layer disposed on the carbon elements that promotes adhesion of the active material to the network. In some such embodiments the thin polymeric layer comprises a self-assembled and or self-limiting polymer layer. In some embodiments, the thin polymeric layer bonds to the active material, e.g., via hydrogen bonding.

In some embodiments the thin polymeric layer may have a thickness in the direction normal to the outer surface of the carbon elements of less 3 times, 2 times, 1 times, 0.5 times, 0.1 times that the minor dimension of the element (or less).

In some embodiments, the thin polymeric layer includes functional groups (e.g., side functional groups) that bond to the active material, e.g., via non-covalent bonding such a π-π bonding. In some such embodiments the thin polymeric layer may form a stable covering layer over at least a portion of the elements.

In some embodiments, the thin polymeric layer on some of the elements may bond with a current collector or and adhesion layer disposed thereon and underlying an active layer containing the energy storage (i.e., active) material. For example, in some embodiments, the thin polymeric layer includes side functional groups that bond to the surface of the current collector or adhesion layer, e.g., via non-covalent bonding such a π-π bonding. In some such embodiments, the thin polymeric layer may form a stable covering layer over at least a portion of the elements. In some embodiments, this arrangement provides for excellent mechanical stability of the electrode.

In some embodiments, the polymeric material is miscible in solvents of the type described in the examples above. For example, in some embodiments the polymeric material is miscible in a solvent that includes an alcohol such as methanol, ethanol, or 2-propanol (isopropyl alcohol, sometimes referred to as IPA) or combinations thereof. In some embodiments, the solvent may include one or more additives used to further improve the properties of the solvent, e.g., low boiling point additives such as acetonitrile (ACN), de-ionized water, and tetrahydrofuran. In this example, the mixture is formed in an NMP free solvent.

Suitable examples of materials which may be used to form the polymeric layer include water soluble polymers such as polyvinylpyrrolidone. In some embodiments, the polymeric material has a low molecular mass, e.g., less than or equal to 1,000,000 g/mol, 500,000 g/mol, 100,000 g/mol, 50,000 g/mol, 10,000 g/mol, 5,000 g/mol, 2,500 g/mol or less.

Note that the thin polymeric layer described above is qualitatively distinct from bulk polymer binder used in conventional electrodes. Rather than filling a significant portion of the volume of the active layer, the thin polymeric layer resides on the surface of the high aspect ratio carbon elements, leaving the vast majority of the void space within available to hold active material particles.

For example, in some embodiments, the thin polymeric layer has a maximum thickness in a direction normal to an outer surface of the network of less than or equal to 1 times, 0.5 times, 0.25 times, or less of the size of the carbon elements 201 along their minor dimensions. For example, in some embodiments the thin polymeric layer may be only a few molecules thick (e.g., less than or equal to 100, 50, 10, 5, 4, 3, 2, or even 1 molecule(s) thick). Accordingly, in some embodiments, less than 10%, 5%, 1%, 0.1%, 0.01%, 0.001% or less of the volume of the active layer 100 is filled with the thin polymeric layer.

In yet further exemplary embodiments, the surface treatment may be formed a layer of carbonaceous material which results from the pyrolyzation of polymeric material disposed on the high aspect ratio carbon elements. This layer of carbonaceous material (e.g., graphitic or amorphous carbon) may attach (e.g., via covalent bonds) to or otherwise promote adhesion with the active material particles. Examples of suitable pyrolyzation techniques are described in U.S. Patent Application Ser. No. 63/028,982 filed May 22, 2020. One suitable polymeric material for use in this technique is polyacrylonitrile (PAN).

TABLE I
Exemplary Parameters for First Step

| Parameters | Motivations | Value | | Comment |
|---|---|---|---|---|
| Temperature | to fully dissolve | R.T. | | no heat needed for some |
| | surfactant | | | solvents (ethanol) |
| | (CTAPF6) | 45° | C. | designed for IPA as solvent |
| | | (35 to 70° C.) | | |
| Duration | | 60 | min | Depending on mix efficiency |
| | | (15 to 75 mins) | | |
| | | 100 | min | initially designed for larger |
| | | (80 to 120 mins) | | volume ≥ 1.0 L |
| Dispersion | should be adjusted to | ~700 | rpm | for low viscosity/small |
| Speed | 1) make sure all salts | (300 to 900 rpm) | | volume |
| | dissolved, 2) avoid | 1000 | rpm | |
| | unwanted CNT | (800 to 1200 rpm) | | |
| | precipitation | ~1300 | rpm | for high viscosity/high volume/ |

| | |
|---|---|
| (1100 to 1500 rpm) | no temperature heat |

Referring to FIG. 6, in the second step 42, active material is added to the carbon dispersion formed in the first step 41. The active material may be provided as particles or in other suitable forms.

In various embodiments, the active material may include any active material suitable for use in energy storage devices, including metal oxides such as lithium metal oxides. For example, the active material may include lithium cobalt oxide (LCO, sometimes called “lithium cobaltate” or “lithium cobaltite,” is a chemical compound with one variant of possible formulations being LiCoO₂); lithium nickel manganese cobalt oxide (NMC, with a variant formula of LiNiMnCo); lithium manganese oxide (LMO with variant formulas of LiMn₂O₄, Li₂MnO₃ and others); lithium nickel cobalt aluminum oxide (LiNiCoAlO₂ and variants thereof as NCA) and lithium titanate oxide (LTO, with one variant formula being Li₄Ti₅O₁₂); lithium iron phosphate oxide (LFP, with one variant formula being LiFePO₄), lithium nickel cobalt aluminum oxide (and variants thereof as NCA) as well as other similar other materials. Other variants of the foregoing may be included.

In some embodiments where NMC is used as an active material, nickel rich NMC may be used. For example, in some embodiments, the variant of NMC may be LiNiₓMn_{y}Co_{1-x-y}, where x is equal to or greater than about 0.7, 0.75, 0.80, 0.85, or more. In some embodiments, so called NMC811 may be used, where in the foregoing formula x is about 0.8 and y is about 0.1.

In some embodiments, the active material includes other forms of lithium nickel manganese cobalt oxide (LiNiₓMn_{y}Co_{z}O₂). For example, common variants such as, without limitation: NMC 111 (LiNi_{0.33}Mn_{0.33}Co_{0.33}O₂); NMC 532 (LiNi_{0.5}Mn_{0.3}Co_{0.2}O₂); NMC 622 (LiNi_{0.6}Mn_{0.2}Co_{0.2}O₂); and others may be used.

In some embodiments, e.g., where the electrode is used as an anode, the active material may include graphite, hard carbon, activated carbon, nanoform carbon, silicon, silicon oxides, carbon encapsulated silicon nanoparticles. In some such embodiments an active layer of the electrode may be intercalated with lithium, e.g., using pre-lithiation methods known in the art.

In some embodiments, the techniques described herein may allow for the active layer be made of in large portion of material in the active layer, e.g., greater than 75%, 80%, 85%, 90%, 95%, 99%, 99.5%, 99.8% or more by weight, while still exhibiting excellent mechanical properties (e.g., lack of delamination during operation in an energy storage device of the types described herein). For example, in some embodiments, the active layer may have such aforementioned high amount of active material and a large thickness (e.g., greater than 50 μm, 100 μm, 150 μm, 200 μm, or more), while still exhibiting excellent mechanical properties (e.g., a lack of delamination during operation in an energy storage device of the types described herein).

Particles of the active material may be characterized by a median particle sized in the range of e.g., 0.1 μm and 50 micrometers μm, or any subrange thereof. The particles of active material may be characterized by a particle size distribution which is monomodal, bi-modal or multi-modal particle size distribution. The particles of active material may have a specific surface area in the range of 0.1 meters squared per gram (m²/g) and 100 meters squared per gram (m²/g), or any subrange thereof. In some embodiments, the active layer may have mass loading of particles of active material e.g., of at least 20 mg/cm², 30 mg/cm², 40 mg/cm², 50 mg/cm², 60 mg/cm², 70 mg/cm², 80 mg/cm², 90 mg/cm², 100 mg/cm², or more.

TABLE II
Parameters for Addition of Active Material

| Parameters | Motivations | Value | | Comment |
|---|---|---|---|---|
| Dispersion | should be | ~700 | rpm | for low |
| Speed | maximized | (600 to 1000 rpm) | | viscosity/small |
| | while avoid | | | volume or dry room |
| | splash | | | condition, no NCM |
| | | | | aggregation |
| | | 1000 | rpm | |
| | | (800 to 1200 rpm) | | |
| | | ~1300 | rpm | for high viscosity/ |

| | |
|---|---|
| (1100 to 1500 | high volume/ |
| rpm) | no heat |

In the third step 43, dispersants and additives are added to the mixture. An example of a dispersant is PVP. Polyvinylpyrrolidone (PVP), also commonly called “polyvidone” or “povidone,” is a water-soluble polymer made from the monomer N-vinylpyrrolidone. Generally, the dispersant serves as an emulsifier and disintegrant for solution polymerization and as a surfactant, reducing agent, shape controlling agent and dispersant in nanoparticle synthesis and their self-assembly. Another example of a dispersant includes AQUACHARGE, which is a tradename for an aqueous binder for electrodes, that was developed by applying water-soluble resin technology. AQUACHARGE is produced by Sumitomo Seika Chemicals Co., Ltd. of Hyogo Japan. A similar example is provided in U.S. Pat. No. 8,124,277, entitled “Binder for electrode formation, slurry for electrode formation using the binder, electrode using the slurry, rechargeable battery using the electrode, and capacitor using the electrode,” and incorporated herein by reference in its entirety. Further examples include polyacrylic acid (PAA) which is a synthetic high-molecular weight polymer of acrylic acid as well as sodium polyacrylate which is a sodium salt of polyacrylic acid.

TABLE III

| Parameters | Motivations | Value | | Comment |
|---|---|---|---|---|
| Duration | | 60 | min | Low Specific Capacity (mAh/g) for |
| | | (40 to 80 mins) | | Cathode and Anode Electrodes |
| | | 120 | min | High Specific Capacity (mAh/g) for |
| | | (90 to 150 mins) | | Cathode and Anode Electrodes |
| Dispersion | should be | ~800 | rpm | for low viscosity/small volume |
| Speed | maximized | (600 to 1000 rpm) | | |
| | while avoid | 1000 | rpm | Experiments show 1300-1400 rpm is |

| | | |
|---|---|---|
| splash | (800 to 1200 rpm) | better for mixing dispersant additives |
| | | (ex. PVP) in slurry |
| | ~1300-1400 rpm | for high viscosity/high volume |
| | (1200 to 1600 rpm) | |

TABLE IV
Target Viscosity Range of Slurry

| Shear Rate (rpm) | Viscosity (mPa s) |
|---|---|
| 6 | 20000-10000 |
| 12 | 6000-3000 |
| 30 | 3000-1500 |
| 60 | 1200-800 |

In the fourth step 44, coating of the current collector with the slurry and then drying of the coated assembly occurs. In some embodiments, the final slurry may be formed into a sheet, and coated directly onto the current collector or an intermediate layer such as an adhesion layer as appropriate. In some embodiments, the final slurry may be applied to through a slot die to control the thickness of the applied layer. In other embodiments, the slurry may be applied and then leveled to a desired thickness, e.g., using a doctor blade. A variety of other techniques may be used for applying the slurry. For example, coating techniques may include, without limitation: comma coating; comma reverse coating; doctor blade coating; slot die coating; direct gravure coating; air doctor coating (air knife); chamber doctor coating; off set gravure coating; one roll kiss coating; reverse kiss coating with a small diameter gravure roll; bar coating; three reverse roll coating (top feed); three reverse roll coating (fountain die); reverse roll coating and others.

The viscosity of the final slurry may vary depending on the application technique. For example, for comma coating, the viscosity may range between about 1,000 cps to about 200,000 cps. Lip-die coating provides for coating with slurry that exhibits a viscosity of between about 500 cps to about 300,000 cps. Reverse-kiss coating provides for coating with slurry that exhibits a viscosity of between about 5 cps and 1,000 cps. In some applications, a respective layer may be formed by multiple passes.

TABLE V
Coating and Drying

| Parameters | Motivations | Value | | Comment |
|---|---|---|---|---|
| Blade dispersion | resolve the active | blade dispersion | | lower specific capacity, higher areal |
| and mixing | material (e.g., NMC | | | loading in the last portion of slurry. |
| before coating | material) | mixing up and | | mixing up and down the slurry, right |
| | high density induced | down right before | | before each coating, very uniform and |
| | non uniformity issue | coating | | consistent loading with similar active |
| | | | | material (NMC/Graphite/SiOx) |
| | | | | content. |
| Coating Speed | higher coating speed is | 30 | mm/s | initial value used |
| | good for 3 D nano- | | | |
| | carbon based slurry | | | |
| | Shear thinning | 60 | mm/s | better coating compared to 30 mm/s |
| | behavior | 120 | mm/s | reduce the chunk significantly |
| | of 3 D nano-carbon | (60-180 mm/s) | | |
| | based slurry | 180 | mm/s | May be used for certain active |

materials

In the fifth step 45, calendaring is performed. In some embodiments, the layer formed from the final slurry may be compressed (e.g., using a calendaring apparatus) before or after being applied to the current collector (directly or upon an intermediate layer). In some embodiments, the slurry may be partially or completely dried (e.g., by applying heat, vacuum or a combination thereof) prior to or during the calendaring (i.e., compression) process. For example, in some embodiments, the layer may be compressed to a final thickness (e.g., in the direction normal to the current collector layer 101) of less than 90%, 80%, 70%, 50%, 40%, 30%, 20%, 10% or less of its pre-compression thickness.

In various embodiments, when a partially dried layer is formed during a coating or compression process, the layer may be subsequently fully dried, (e.g., by applying heat, vacuum or a combination thereof). In some embodiments, substantially all of the solvent is removed from the active layer 100.

In some embodiments, solvents used in formation of the slurries are recovered and recycled into the slurry-making process.

In some embodiments, the layer may be compressed, e.g., to break some of the constituent high aspect ratio carbon elements or other carbonaceous material to increase the surface area of the respective layer. In some embodiments, this compression treatment may increase one or more of adhesion, ion transport rate, and surface area. In various embodiments, compression can be applied before or after the layer is applied to or formed on the electrode.

In some embodiments where calendaring is used to compress the layer, the calendaring apparatus may be set with a gap spacing equal to less than 90%, 80%, 70%, 50%, 40%, 30%, 20%, 10% or less of the pre-compression thickness of the layer (e.g., set to about 33% of the pre-compression thickness of the layer). The calendar rolls can be configured to provide suitable pressure, e.g., greater than 1 ton per cm of roll length, greater than 1.5 ton per cm of roll length, greater than 2.0 ton per cm of roll length, greater than 2.5 ton per cm of roll length, or more. In some embodiments, the post compression layer will have a density in the range of 1 g/cc to 10 g/cc, or any subrange thereof such as 2.5 g/cc to 4.0 g/cc. In some embodiments the calendaring process may be carried out at a temperature in the range of 20° C. to 140° C. or any subrange thereof. In some embodiments the layer may be pre-heated prior to calendaring, e.g., at a temperature in the range of 20° C. to 100° C. or any subrange thereof.

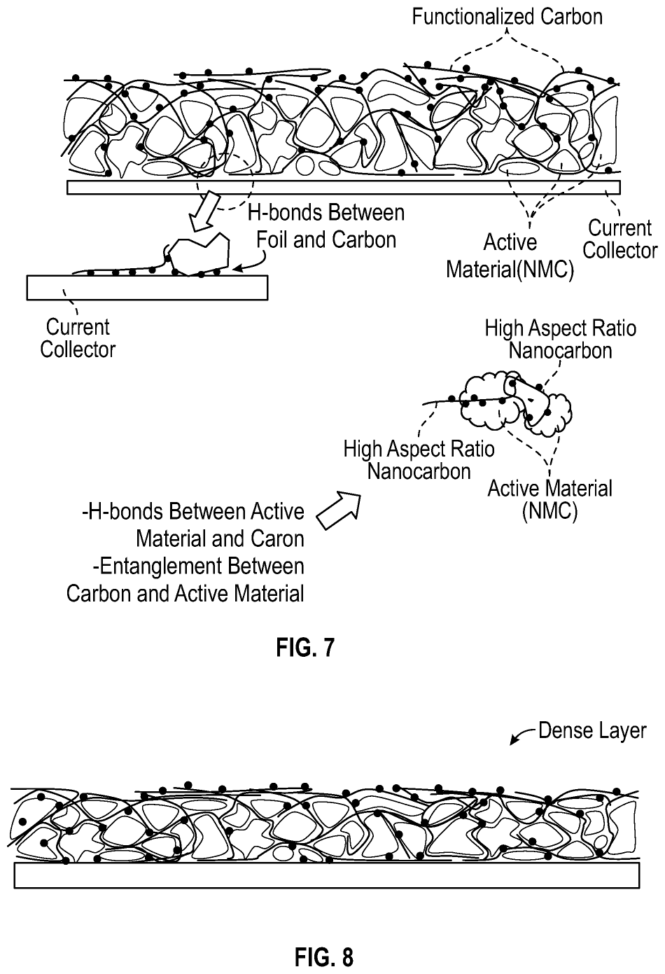

Aspects of fabrication of the layer on the current collector are shown in FIGS. 7 and 8. In FIG. 7, it may be seen that active material is dispersed within a network of functionalized carbon. The network of functionalized carbon with the active material is disposed on the current collector. Referring also to FIG. 8, it may be seen that after a calendaring process, the combination of active material and functionalized carbon nanomaterials result in a dense layer disposed on the current collector.

TABLE VI
Calendaring Parameters

| Parameters | Motivations | Value | Comment |
|---|---|---|---|
| Gap | | 10 μm | |
| | | (0 to 30 μm) | |
| Times | flip side for better | 2 | initial value used, good for high mass |
| | uniformity | | loading based electrodes (≥40 mg/cm²) |
| | | | loading. |
| | increase times for | 4 | moderate density and good uniformity |
| | higher density | 8 | for reaching ≥ 3.4 g/cc cathode electrodes |
| | | | for low mass loading based electrodes |
| | | | (≤15 mg/cm²) loading |

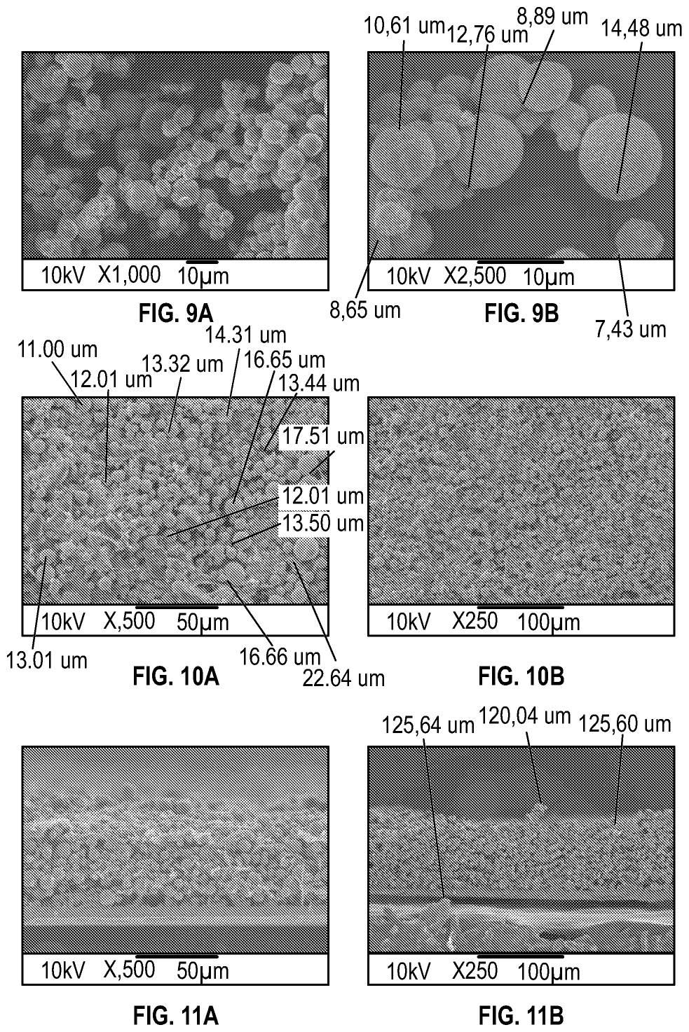

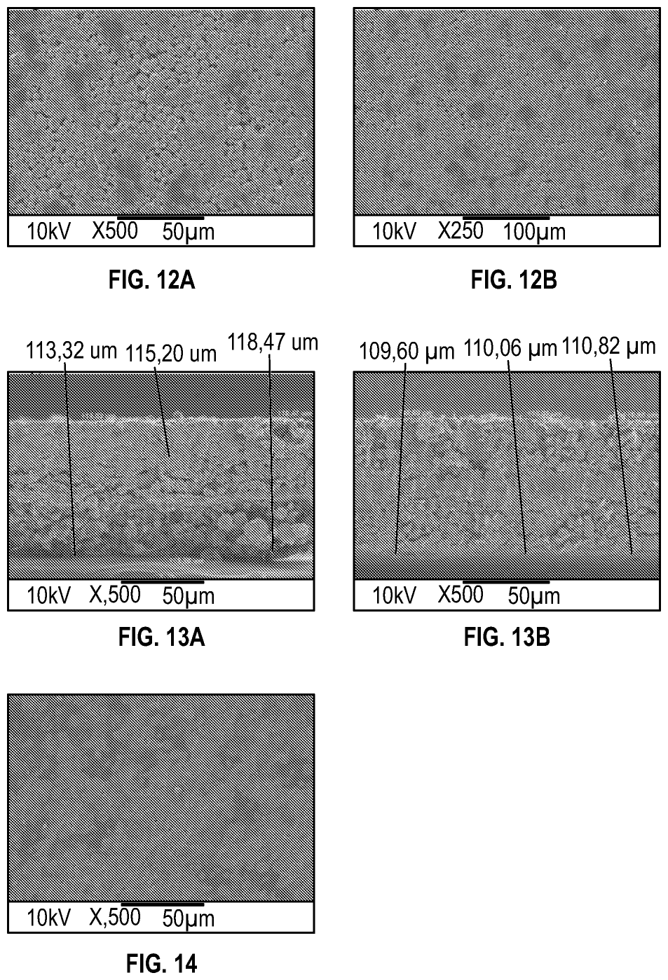

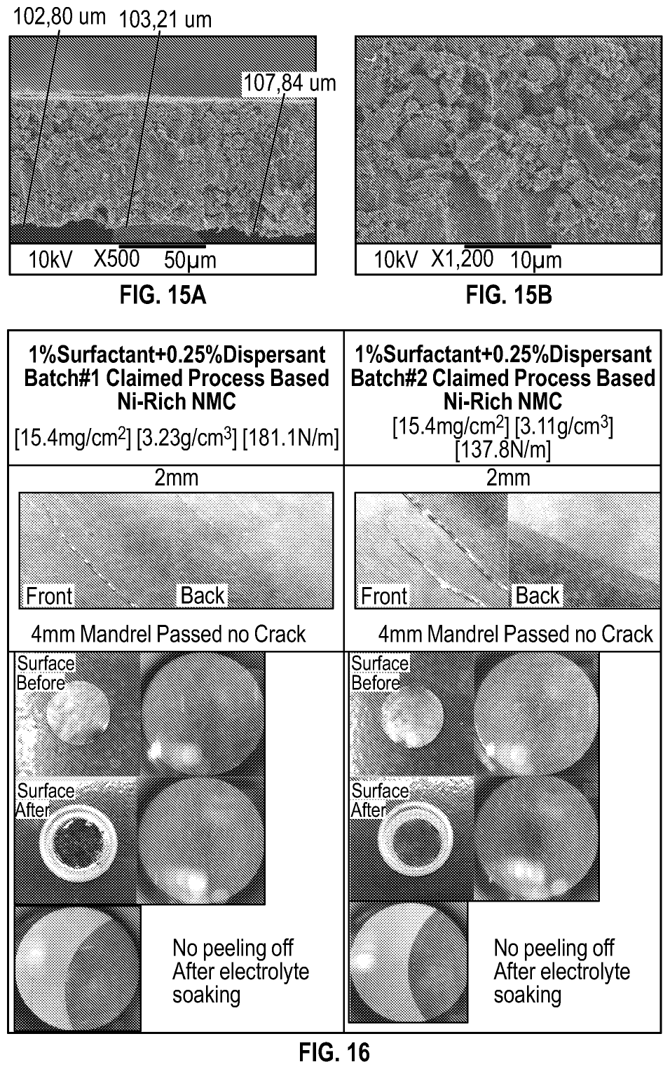

FIG. 9 though 15 are micrographs depicting aspects of active materials and cross sections of layers of active materials fabricated according to the teachings here. FIGS. 9A and 9B, collectively referred to herein as FIG. 9, depict powders rich in nickel and useful in the active materials. FIGS. 10A and 10B, collectively referred to herein as FIG. 10, depict surface morphology of electrodes fabricated with NMC materials that were rich in nickel. In these examples, the electrodes were viewed after the coating and drying process. The materials were fabricated with 1% surfactant (CTAPF6); 0.25% dispersant (PVP) and 3% 3D nano-carbon materials. The active materials were coated on a single side of aluminum foil as the current collector. FIGS. 11A and 11B, collectively referred to herein as FIG. 11, depict the electrode of FIG. 10 from a side cross-sectional view. FIGS. 12A and 12B, collectively referred to herein as FIG. 12, depict the electrode of FIGS. 10 and 11 from a mid-section cross-sectional view.

FIGS. 13A and 13B, collectively referred to herein as FIG. 13, depict cross-sectional side views of electrodes fabricated with NMC materials that were rich in nickel. In these examples, the electrodes were viewed after the coating and drying process. The materials were fabricated with 1% surfactant (CTAPF6); 0.25% dispersant (PVP) and 3% 3D nano-carbon materials. The active materials were coated on both sides of an aluminum foil sheet as the current collector. Mass loading of the active material was about 15 mg/cm² and press density was about 3.5 gm/cm³. FIG. 14, depicts a top cross-sectional view the electrode of FIG. 13. FIGS. 15A and 15B, collectively referred to herein as FIG. 15, depict another top cross-sectional view of the electrode of FIGS. 13 and 14. FIG. 16 is a graphic depicting aspects of mechanical testing for two separate batches of active materials.

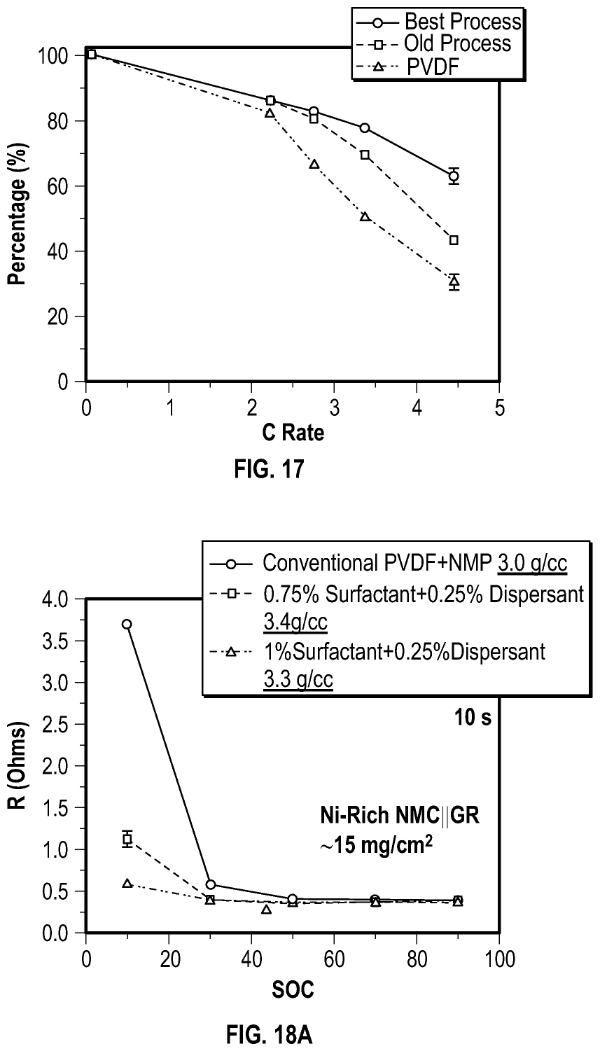

FIG. 17 is a graph depicting is C rate for a half-cell constructed according to the teachings herein. The half-cell included areal loading of NCM active material that was 22.5 mg/cm². In this example, the “best process” curve represents binder-free electrodes fabricated according to the teachings herein. The “old process” curve represents binder-free electrodes fabricated without these surfactants and dispersants disclosed herein. The “PVDF” curve represents performance for cells using electrodes fabricated with prior art technology. In this example, the half-cell was of pouch cell construction. Initial specific and C-Rate test results at provided in the table below. The working electrode size was 45×45 mm, Li counter electrode 46×46 mm. Electrolyte was 1M LiPF6 in EC/DMC (1/1 by vol)+1% VC.

### Data for FIG. 17

| Electrode Manufacturing | Press | Initial Discharge | ICE, |
|---|---|---|---|
| Process (~15 mg/cm²) | Density | Specific Capacity | % |
| 1% Surfactant + | 3.1 g/cc | 204 mAh/g | 98% |
| 0.25% Dispersant + | | | |
| 3% − 3 D nano-carbon | | | |
| 1% Surfactant + | 3.5 g/cc | 204 mAh/g | 98.5% |
| 0.25% Dispersant + | | | |
| 3% − 3 D nano-carbon | | | |
| Conventional PVDF + | 3.5 g/cc | 194 mAh/g | 94.2% |
| NMP process | | | |

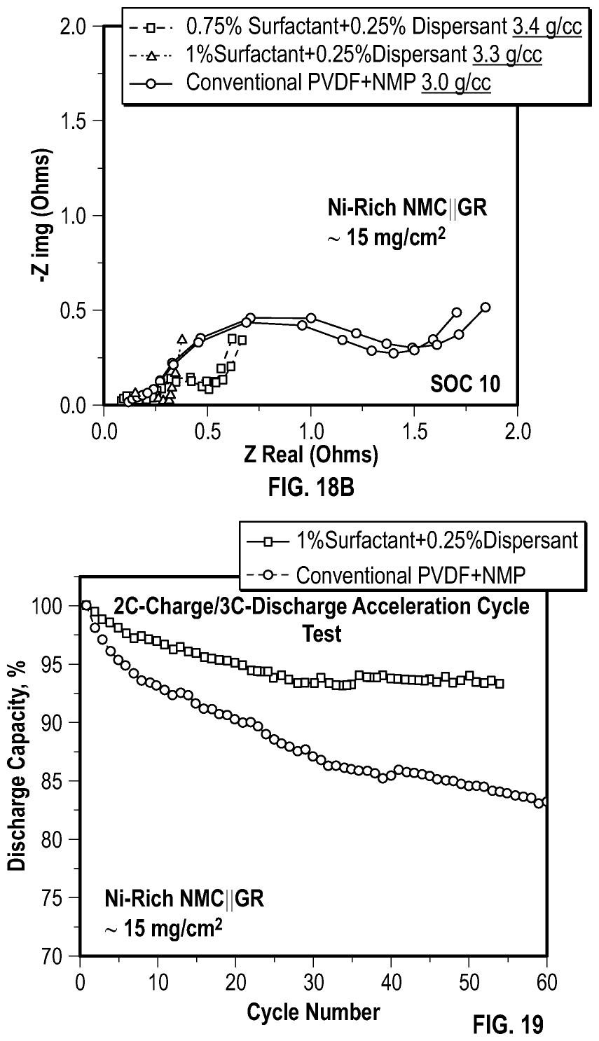

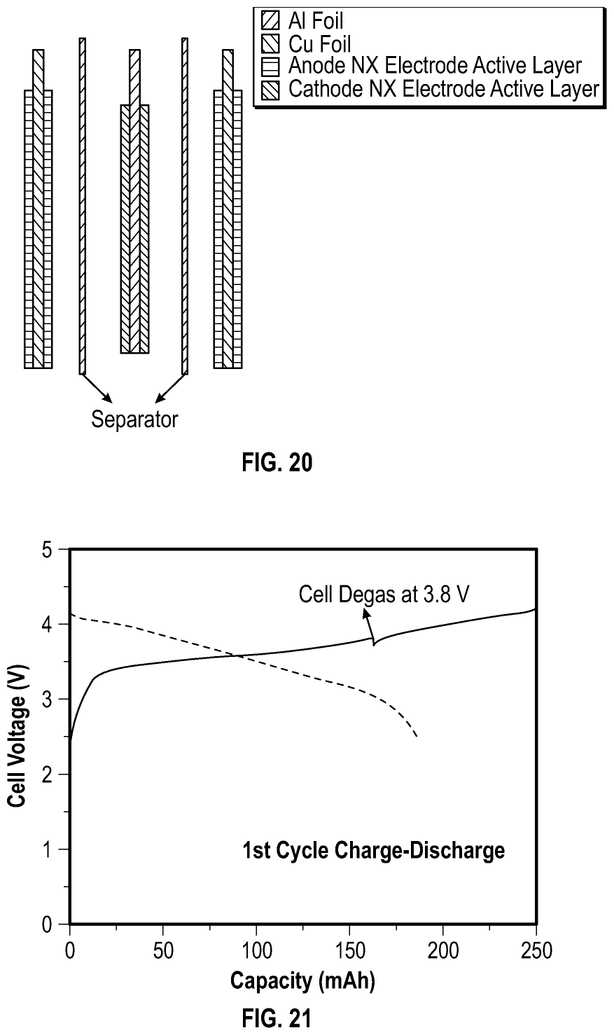

In FIG. 18, test results are shown for a full pouch cell. In this example, the cathode was Ni-rich NMC with 45×45 mm and the anode was graphite electrodes with 46×46 mm. The electrolyte was 1M LiPF6 in EC/DMC (1/1 by vol)+1% VC. N/P ratio=˜1.1. It may be seen that HPPC resistance is much lower compared with traditional PVDF process. As shown in FIG. 19, lower charge resistance in cathodes according to the teachings herein results in improved performance at ten percent state-of-charge. FIG. 20 shows that cycling stability is improved with a cathode fabricated according to the teachings herein.

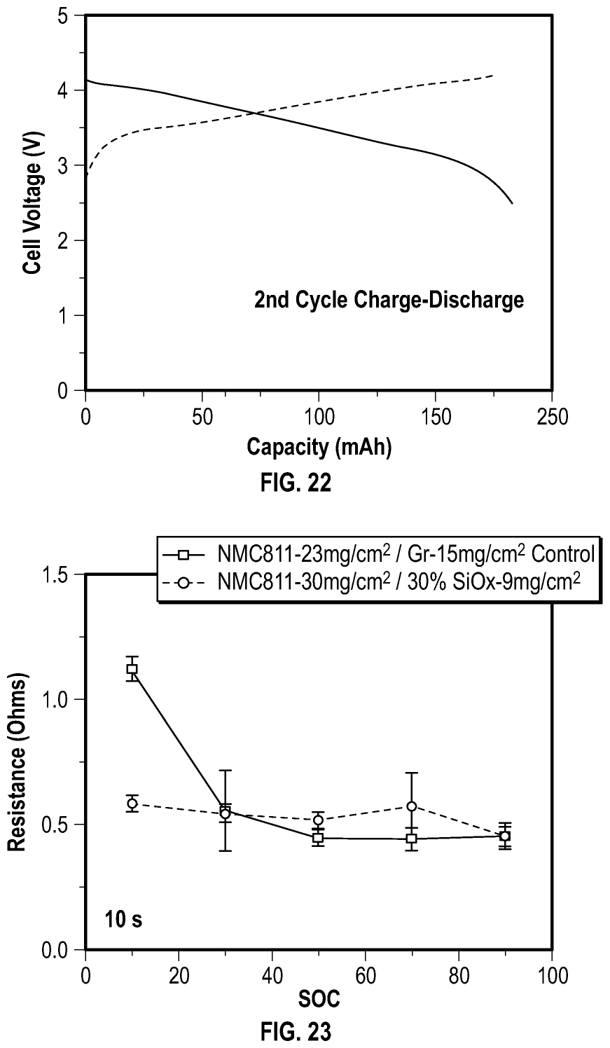

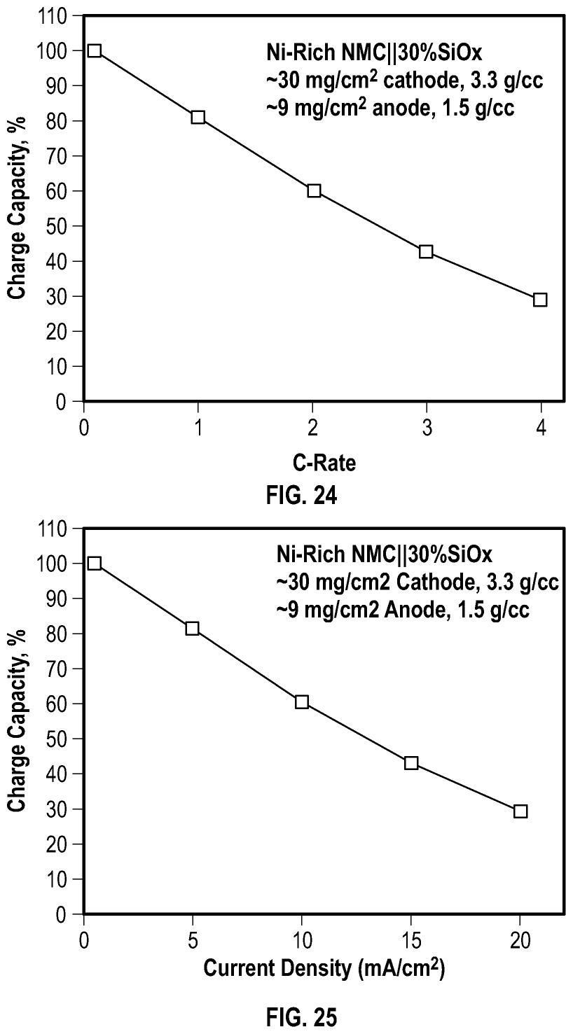

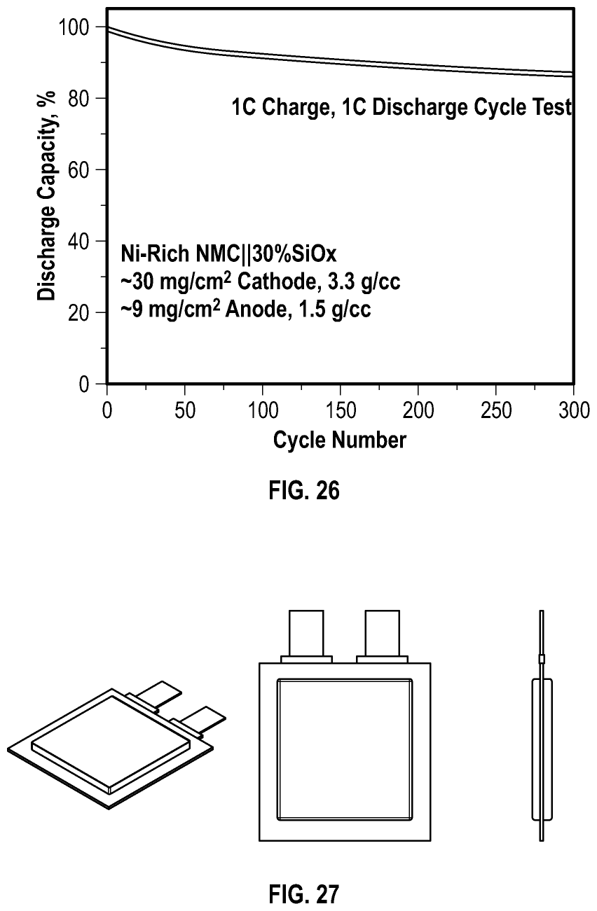

Another pouch cell was constructed for testing. Structure of the pouch cell is set forth in FIG. 21. In this second embodiment, the cathode was Ni-rich NMC with 45×45 mm, 28-30 mg/cm² mass loading, and the anode was a combination of graphite/SiOₓ (45% SiOₓ) electrodes with 46×46 mm, 8-9 mg/cm² mass loading. The electrolyte was 1.1M LiPF6 in PC:FEC:EMC:DEC=20:10:50:20. N/P ratio=˜1.04 to 1.10. Both NMC cathode and 45% SiOx anode electrode manufacturing process were used with the process set forth herein and use a hybrid surfactant and dispersant combined with 3D nano-carbon matrix (e.g., a NX electrode). The Li-ion battery full cell specific energy was about 332 Wh/kg with 90% pouch cell package efficiency, and 351 Wh/kg if the package efficiency increases to 95%. The energy density was about 808 Wh/L with 90% pouch cell package efficiency and 10% pouch cell volume expansions, and the energy density was about 853 Wh/L with 95% pouch cell package efficiency and 10% pouch cell volume expansions. The initial 1st cycle charge specific capacity of the cathode and anode based on claimed electrode manufacturing process was about 228 mAh/g and 852 mAh/g; the initial 1st cycle discharge specific capacity of the cathode and anode based on claimed electrode manufacturing process was about 210 mAh/g and 750 mAh/g. LiB full cell capacity in this example is 1st charge capacity 240 mAh, and 1st discharge capacity 216 mAh from 4.2 to 2.5 V under 0.1C-Rate constant current charge-discharge. The initial coulombic efficiency is about ˜90%. Aspects of this data and electrical performance for this cell are set forth in FIGS. 22 through 26.

Example properties of a cell using the resulting electrodes are set forth in the table below. Further, the exemplary cell did not exhibit cracking or stress as may commonly arise with some physical tests.

| Cell NX NMC811 \|\| 45% SiOx-2 | Cathode | Anode | Unit |
|---|---|---|---|
| Active Layer Weight | 1.194 | 0.344 | g |
| Al Foil weight | 0.086 | | g |
| Cu Foil weight | | 0.173 | g |
| Active Layer Thickness | 0.168 | 0.13 | mm |
| Porosity | 18.30% | 25.00% | |
| Al Foil Thickness | 0.015 | | mm |
| Cu Foil Thickness | | 0.008 | mm |
| Electrolyte weight in electrodes | 0.07470792 | 0.082524 | g |
| Separator weight | 0.033 | | g |
| Separator thickness | 0.04 | | mm |
| Electrolyte weight in separator | 0.05517792 | | g |
| Total cell weight | 2.04240984 | | g |
| Total cell volume | 0.763876 | | mL |
| First Discharge Energy from 4.2 to 2.5 V | 0.7548 | | Wh |
| Energy Density without packaging | 369.5634369 | | Wh/kg |
| Energy Density with packaging | 332.6070932 | | Wh/kg |
| (90% packaging efficiency) | | | |
| Energy Density with packaging | 351.085265 | | Wh/kg |
| (95% packaging efficiency) | | | |
| Energy Density without packaging | 988.1184904 | | Wh/L |
| Energy Density with packaging | 899.1878263 | | Wh/L |
| (91% packaging efficiency) | | | |
| Energy Density with packaging | 948.5937508 | | Wh/L |
| (96% packaging efficiency) | | | |
| Energy Density with packaging | 862.3579553 | | Wh/L |
| (96% packaging efficiency) | | | |
| and 10% volume expansions | | | |

FIG. 27 illustrates an example battery cell using an example of the electrode disclosed herein (e.g., a NX electrode). The battery cell had a dimension of approximately 46.5 mm×48.5 mm×7.14 mm. The battery cell illustrated in FIG. 27 corresponds to a 1.5-3.5 Ah battery cell. The illustrated battery cell (e.g., having an NX NMC811 electrode) exhibited a 1st cycle charge specific capacity of greater than or equal to 210 mAh/g, and an areal capacity of substantially 5.6 mAh/cm².

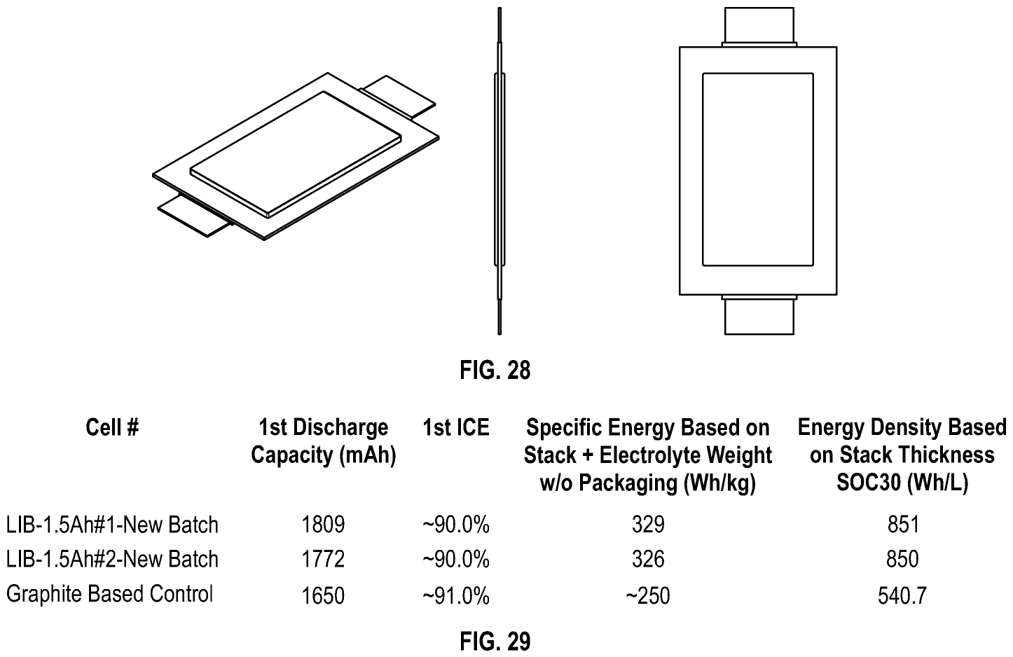

FIG. 28 illustrates an example battery cell using an example of the electrode disclosed herein (e.g., a NX electrode such as an electrode comprising a 3D nano-carbon matrix). The battery cell had a dimension of approximately 62 mm×107 mm×5.4 mm. The battery cell illustrated in FIG. 28 corresponds to a 9.0-12.0 Ah battery cell. The illustrated battery cell (e.g., having an NX NMC811 electrode) exhibited a 1st cycle charge specific capacity of greater than or equal to 1116 mAh/g, and an areal capacity of substantially 6.5 mAh/cm².

FIG. 29 illustrates a chart of properties for various examples of battery cells (e.g., pouch cells). The battery cells had a dimension of approximately 46 mm×46 mm×3 mm. The battery cell package efficiency is about −86% for 9 layers of a NMC811 cathode and 10 layers of a Si anode (e.g., a 1.5 Ah cell); however, the cell package efficiency may be increased to 95% efficiency in large-format pouch cells >5 Ah with more stack layers. Results show that Si anode (5.5-5.0 mg/cm2) can improve specific energy by at least 30% and energy density compared with graphite anode electrodes (16 mg/cm2 to match 24 mg/cm2 NX NMC811 cathode) with the same small pouch cell format and layer numbers.

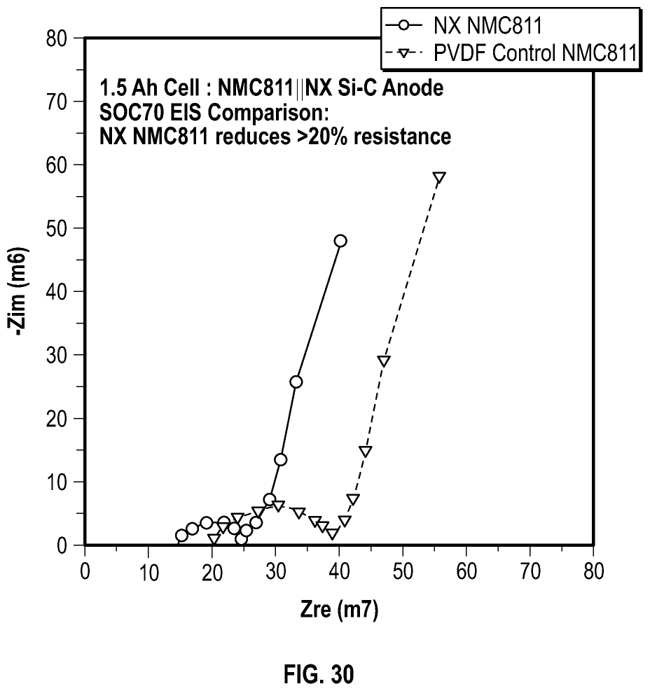

FIG. 30 illustrates a graph comparing performance of a battery cell comprising a cathode according to various embodiments compared to a control battery cell having a conventional PVDF cathode. As illustrated in FIG. 30, the use of the cathode having the 3D nano-carbon matrix (e.g., NX NMC811) reduces resistance by at least 20%.

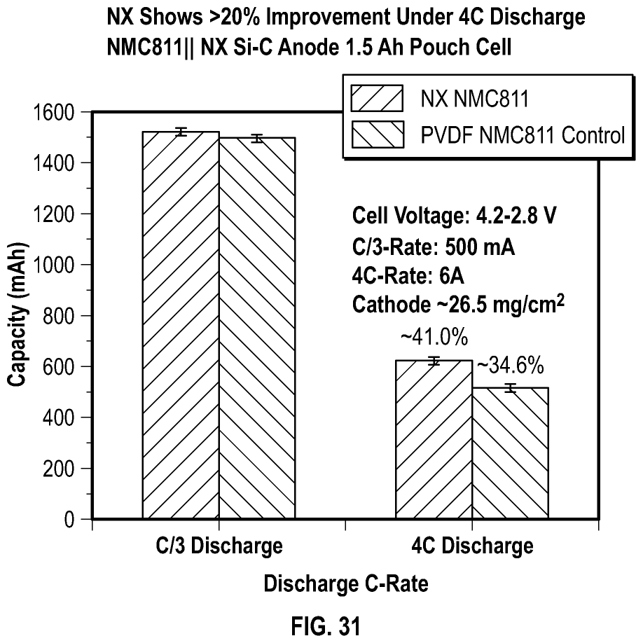

FIG. 31 illustrates a chart comparing performance of a battery cell comprising a cathode according to various embodiments compared to a control battery cell having a conventional PVDF cathode. As illustrated in FIG. 31, the use of the cathode having the 3D nano-carbon matrix (e.g., NX NMC811) reduces resistance by at least 20%.

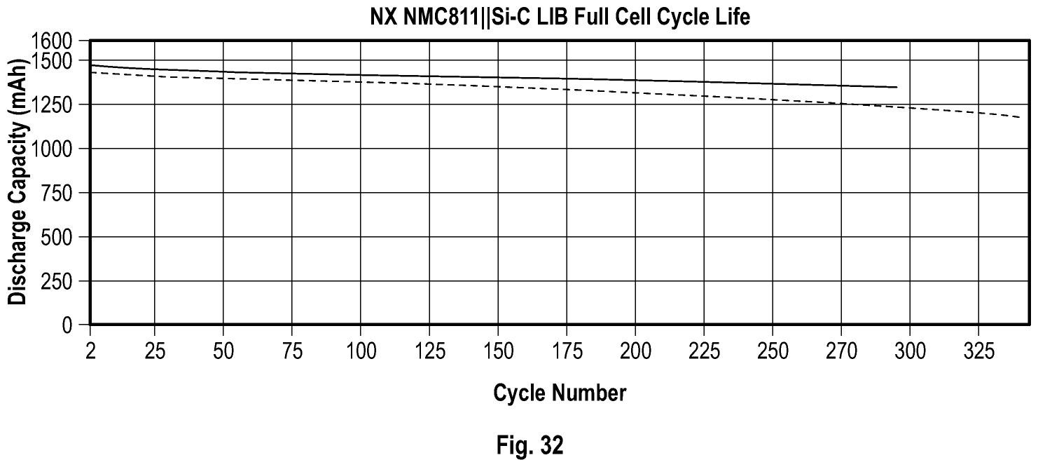

FIG. 32 illustrates a graph comparing performance of a battery cell comprising a cathode according to various embodiments compared to a control battery cell having a conventional PVDF cathode. The battery cells compared in FIG. 32 comprise a NX Si—C anode electrode (e.g., an electrode having a 3D nano-carbon matrix), are 1.5 Ah cells, and is measured according to a 1C1C cycling of 4.2-2.8V. As illustrated in FIG. 32, the use of the cathode having the 3D nano-carbon matrix (e.g., NX NMC811) has a larger discharge density, and the difference in the discharge density increases as the cycle number increases. After 250 cycles, the battery cell according to various embodiments (e.g., a battery cell having a cathode comprising a 3D nano-carbon matrix) has a discharge capacity that is at least 1275 mAh, and preferably at least 1375 mAh. After 250 cycles, the battery cell according to various embodiments (e.g., a battery cell having a cathode comprising a 3D nano-carbon matrix) has a discharge capacity that is approximately 10% greater than a control battery cell (e.g., a battery cell having a cathode comprising PVDF).

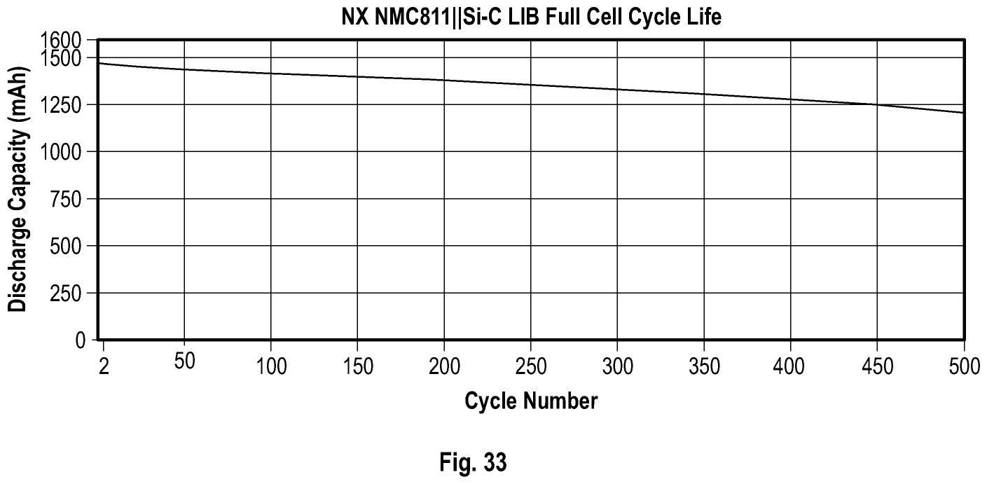

FIG. 33 illustrates a graph illustrating performance of a battery cell comprising an electrode according to various embodiments. The battery cells measured in FIG. 33 comprise a NX Si—C anode electrode (e.g., an electrode having a 3D nano-carbon matrix), a cathode according to various embodiments (e.g., a cathode having a 3D nano-carbon matrix), are 1.5 Ah cells, and is measured according to a 1C1C cycling of 4.2-2.8V. As illustrated in FIG. 33, the battery cell comprising the cathode having the 3D nano-carbon matrix (e.g., NX NMC811) has a discharge capacity retention of approximately 82.7% after 500 cycles. The battery cell comprising the cathode having the 3D nano-carbon matrix (e.g., NX NMC811) has a discharge capacity that decreases less than 300 mAh after 500 cycles.

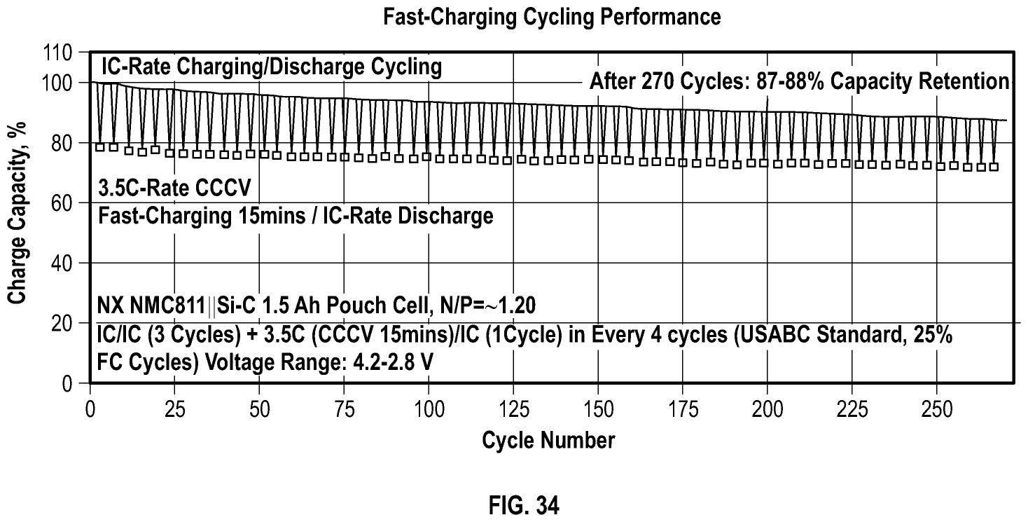

FIG. 34 illustrates a graph illustrating performance of a battery cell comprising an electrode according to various embodiments. FIG. 34 provides a graph a fast-charging cycling performance. The battery cells measured in FIG. 34 comprise a NX Si—C anode electrode (e.g., an electrode having a 3D nano-carbon matrix), a cathode according to various embodiments (e.g., a cathode having a 3D nano-carbon matrix), are 1.5 Ah cells (e.g., a pouch cell), and is measured according to a 1C/1C (3 cycle)+3.5C (CCCV 15 min)/1C (1 cycles) in every 4 cycles over a voltage range of 4.2-2.8V. As illustrated in FIG. 34, the battery cell comprising the cathode having the 3D nano-carbon matrix (e.g., NX NMC811) has a discharge capacity retention of at least 87% after 500 cycles. In some embodiments, the battery cell comprising the cathode having the 3D nano-carbon matrix (e.g., NX NMC811) has a discharge capacity retention of 87%-88% after 500 cycles. The battery cell comprising the cathode having the 3D nano-carbon matrix (e.g., NX NMC811) has a discharge capacity that decreases less than 300 mAh after 270 cycles.

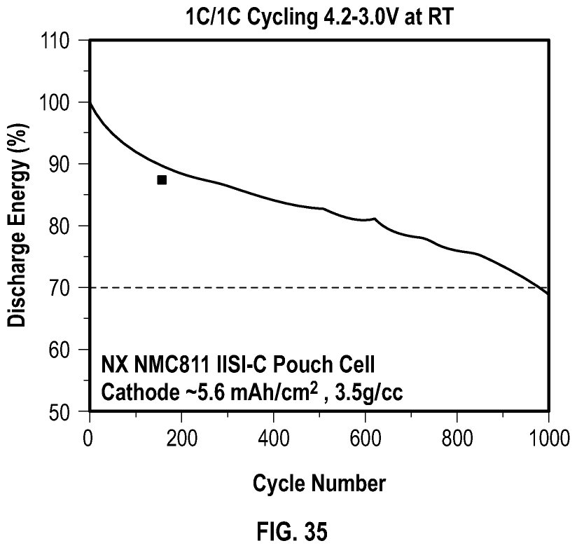

FIG. 35 illustrates a graph illustrating performance of a battery cell comprising an electrode according to various embodiments. FIG. 35 provides a graph of a discharge energy in relation to cycling. The battery cells measured in FIG. 35 comprise a NX Si—C anode electrode (e.g., an electrode having a 3D nano-carbon matrix), a cathode according to various embodiments (e.g., a cathode having a 3D nano-carbon matrix), has a cathode comprising a loading of 5.6 mAh/cm², and an electrode density of 3.5 g/cc, and is measured according to a 1C/1C cycling over a voltage range of 4.2-3.0V. As illustrated in FIG. 35, the battery cell comprising the cathode having the 3D nano-carbon matrix (e.g., NX NMC811) has a discharge capacity retention of at least 70% after 600 cycles, and preferably a discharge capacity retention at least 80% after 600 cycles. In some embodiments, the battery cell comprising the cathode having the 3D nano-carbon matrix (e.g., NX NMC811) has a discharge capacity retention of approximately 70% after 1000 cycles. In some embodiments, the battery cell comprising the cathode having the 3D nano-carbon matrix (e.g., NX NMC811) has a discharge capacity retention of between 80% and 90% after 600 cycles.

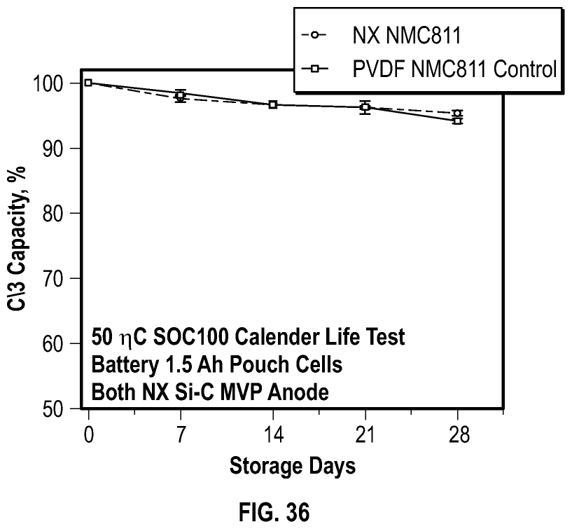

FIG. 36 illustrates a graph illustrating performance of a battery cell comprising an electrode according to various embodiments. FIG. 36 provides a graph of a capacity in relation to storage time. For example, the battery cells were measured according to a 50 degrees Celsius SOC100 calendar life test. The battery cells measured in FIG. 36 are 1.5 Ah pouch battery cells that comprise a NX Si—C anode electrode (e.g., an electrode having a 3D nano-carbon matrix), a cathode according to various embodiments (e.g., a cathode having a 3D nano-carbon matrix). As illustrated in FIG. 36, the battery cell comprising the cathode having the 3D nano-carbon matrix (e.g., NX NMC811) has a capacity retention of at least 95% after 21 days. In some embodiments, the battery cell comprising the cathode having the 3D nano-carbon matrix (e.g., NX NMC811) has capacity retention of approximately at least 95% after 28 days. In some embodiments, the battery cell comprising the cathode comprising the 3D nano-carbon matrix (e.g., NX NMC811) has capacity retention of approximately at least 96% after 28 days. In some embodiments, the battery cell comprising the cathode having the 3D nano-carbon matrix (e.g., NX NMC811) has a capacity retention after 28 days that is at least 1% better than a control 1.5 Ah pouch battery cell having a PVDF cathode.

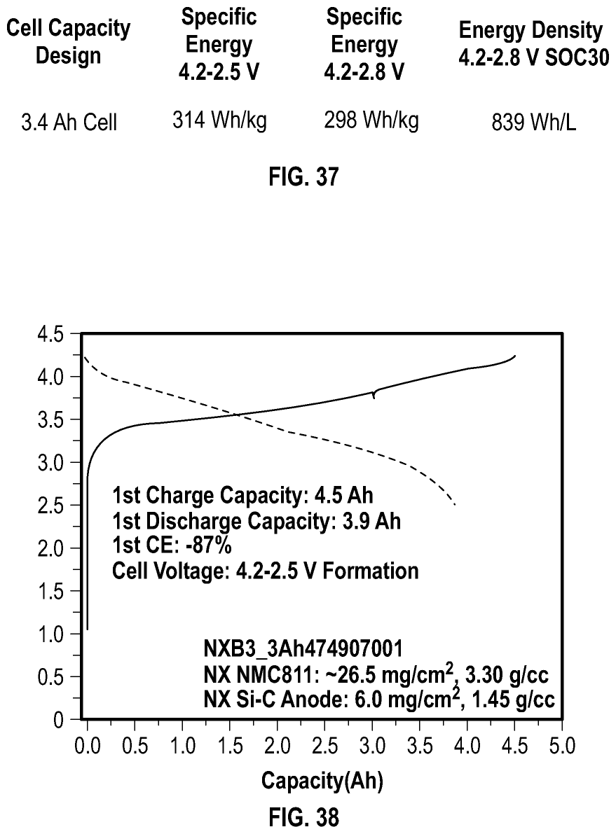

FIGS. 37 and 38 illustrate performance of a battery cell comprising an electrode according to various embodiments of the present application. The battery cell for which performance is provided in FIGS. 37 and 38 is a pouch cell including dimensions of a 46.5 mm×46.5 mm×7.14 mm, and a cathode comprising a 3D nano-carbon matrix (e.g., NX NMC811). FIG. 37 provides a chart that indicates the cell capacity design, the specific energies, and energy density. FIG. 38 provides a graph of the cell voltage in relation to capacity.

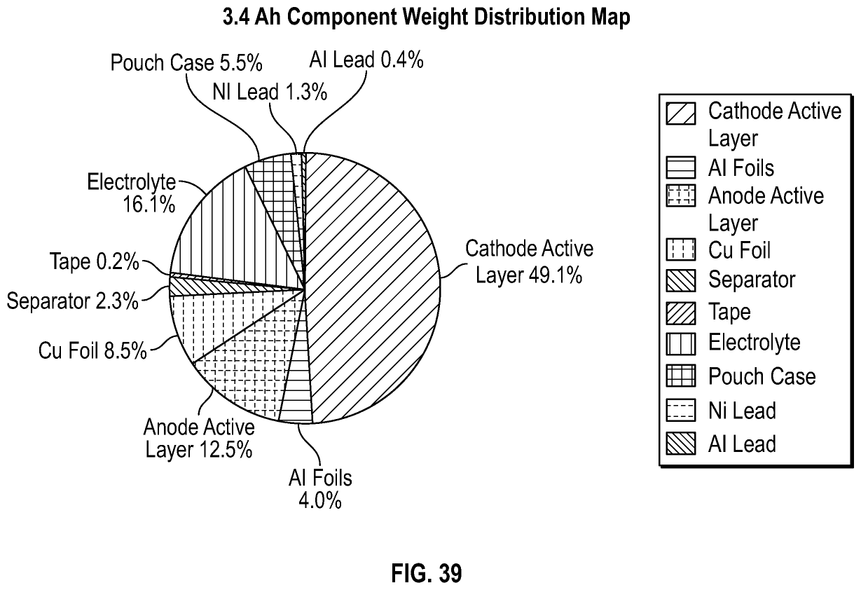

FIG. 39 illustrates a weight distribution of a battery cell according to various embodiments. The battery cell for which weight distribution is measured in FIG. 39 is a 3.4 Ah pouch cell comprising a cathode including the 3D nano-carbon matrix (e.g., NX NMC811).

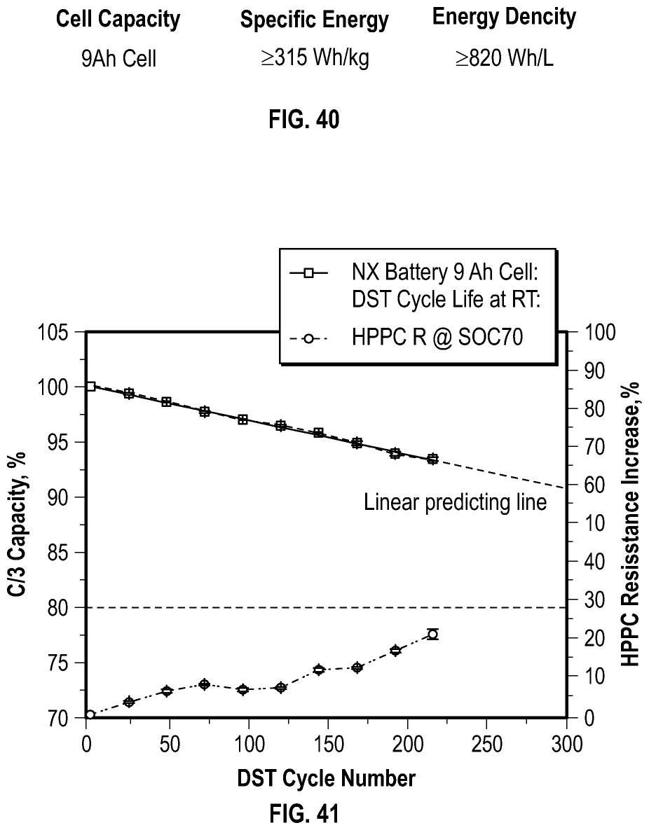

FIGS. 40 and 41 illustrate performance of a battery cell comprising an electrode according to various embodiments of the present application. The battery cell for which performance is provided in FIGS. 40 and 41 is a pouch cell including dimensions of 62 mm×107 mm and 5.4 mm, and a cathode comprising a 3D nano-carbon matrix (e.g., NX NMC811). FIG. 40 provides a chart that indicates the cell capacity design, the specific energies, and energy density. FIG. 41 provides a graph of the capacity relative to DST cycle number. According to various embodiments, the battery cell comprises a specific energy of greater than or equal to 315 Wh/kg, an energy density of greater than or equal to 820 Wh/L, and a cell capacity of 9 Ah. The battery cell according to various embodiments exhibits a DST cycle stability of at least about 70% at 1000 cycles, at least 92.5% at 225 cycles, and/or greater than 90 percent at 300 cycles.

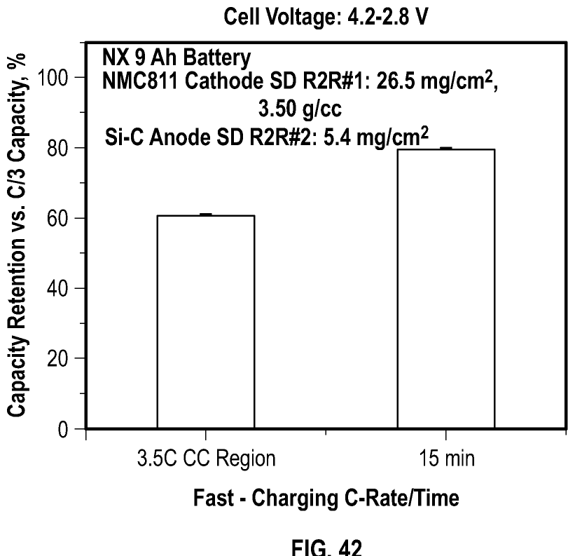

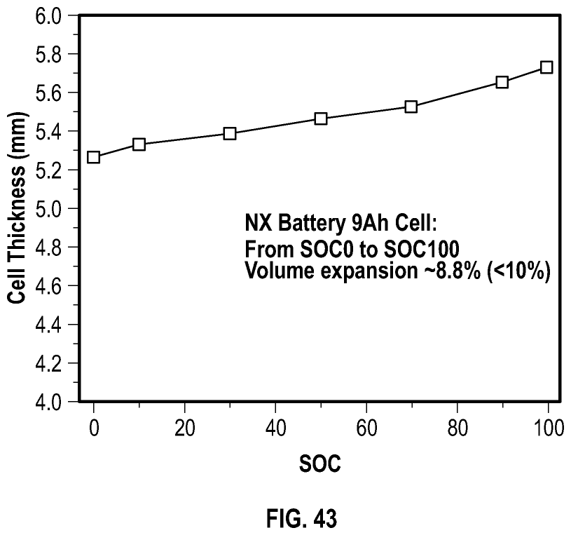

FIGS. 42 and 43 illustrates a chart of a performance of a battery cell comprising an electrode according to various embodiments of the present application. As illustrated in FIG. 43, battery cell according to various embodiments (e.g., a 9 Ah pouch cell comprising a cathode comprising a 3D nano-carbon matrix) exhibits a volume expansion of less than 10% from 0% charge to 100% charge. In some embodiments, such battery cell exhibits a volume expansion of less than 9% from 0% charge to 100%. In some embodiments, such battery cell exhibits a volume expansion of about 8.8% from 0% charge to 100%.

Various other components may be included and called upon for providing for aspects of the teachings herein. For example, additional materials, combinations of materials and/or omission of materials may be used to provide for added embodiments that are within the scope of the teachings herein. A variety of modifications of the teachings herein may be realized. Generally, modifications may be designed according to the needs of a user, designer, manufacturer or other similarly interested party. The modifications may be intended to meet a particular standard of performance considered important by that party.

The appended claims or claim elements should not be construed to invoke 35 U.S.C. § 112(f) unless the words “means for” or “step for” are explicitly used in the particular claim.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. As used herein, the term “exemplary” is not intended to imply a superlative example. Rather, “exemplary” refers to an example of an embodiment that is one of many possible embodiments.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for fabricating an electrode for an energy storage device, the method comprising
heating a mixture of solvent and materials for use as energy storage media;
adding active material to the mixture;
adding dispersant to the mixture to provide a slurry;
coating a current collector with the slurry; and
calendaring the coating of slurry on the current collector to provide the electrode.

2. The method as in claim 1, wherein the energy storage media comprises nanocarbons.

3. The method as in claim 1, wherein the energy storage media comprises high aspect ratio carbon elements.

4. The method as in claim 3, wherein length of a major dimension of the high aspect ratio carbon elements is at least one of: 5 times, 10 times, 100 times, 500 times, 1,000 times, 5,000 times, and 10,000 times a minor dimension thereof.

5. The method as in claim 1, wherein the energy storage media comprises nanocarbon that includes a surface treatment thereof.

6. The method as in claim 5, wherein the surface treatment comprises addition of materials to promote adhesion of the active material to the nanocarbons.

7. The method as in claim 5, wherein the surface treatment comprises addition of at least one of a functional group including at least one of a carboxylic group, a hydroxylic group, an amine group, and a silane group.

8. The method as in claim 5, wherein the surface treatment is formed from at least one of a polymeric layer disposed on the nanocarbon and a lyophilized aqueous dispersion comprising nanocarbon and functionalizing material.

9. The method as in claim 8, wherein the functionalizing material comprises a surfactant.

10. The method as in claim 8, further comprising a pyrolized form of the polymeric layer.

11. The method as in claim 1, wherein the active material comprises at least one of lithium cobalt oxide; lithium nickel manganese cobalt oxide; lithium manganese oxide; lithium nickel cobalt aluminum oxide; lithium titanate oxide; lithium iron phosphate oxide; and lithium nickel cobalt aluminum oxide.

12. The method as in claim 1, wherein particles of the active material comprise a median particle size in the range of 0.1 micrometers to 50 micrometers or any subrange thereof.

13. The method as in claim 1, wherein mass loading of the active material mass is at least 20 mg/cm², 30 mg/cm², 40 mg/cm², 50 mg/cm², 60 mg/cm², 70 mg/cm², 80 mg/cm², 90 mg/cm², 100 mg/cm² or more.

14. The method as in claim 1, wherein the dispersant comprises polyvinylpyrrolidone (PVP).

15. The method as in claim 1, wherein the dispersant comprises at least one of an aqueous binder, polyacrylic acid and sodium polyacrylate.

16. The method as in claim 1, further comprising sintering the coating of slurry.

17. An electrode for an energy storage device, the electrode comprising
a coating of energy storage materials disposed onto a current collector, the coating including a suspension of carbon nanoform materials and active materials in a solvent with a dispersant.

18. An energy storage device comprising the electrode of claim 17, wherein the energy storage device comprises one or more cells, and a volume expansion of at least one cell from a state of charge of 0% to a state of charge of 100% is less than 10%.

19. An energy storage device comprising the electrode of claim 17, wherein the energy storage device comprises one or more cells, and at least one cell exhibits an energy capacity retention of at least 82% at 500 cycles according to a 1C1C cycling at 4.2V to 2.8V.

20. An energy storage device comprising the electrode of claim 17, wherein the energy storage device comprises one or more cells, and at least one cell exhibits of an energy capacity retention at least 87% after 270 fast charging cycles.
